(19) United States
(12) Patent Application Publication
(10) Pub. No.: US 2025/0100901 A1
(43) Pub. Date: Mar. 27, 2025

(54) APPARATUS AND METHOD FOR SUPPLYING SAFE POTABLE WATER

(71) Applicant: Bluesen Co., Ltd., Daegu (KR)

(72) Inventors: Changsik SON, Busan (KR); Youjung KIM, Busan (KR); Kyungyup HWANG, Busan (KR); Hyunchul CHOI, Busan (KR); Kyungsuk YU, Daegu (KR); Jiun LEE, Daegu (KR); Kyungwoo KIM, Busan (KR)

(21) Appl. No.: 18/674,072

(22) Filed: May 24, 2024

(30) Foreign Application Priority Data
Sep. 26, 2023 (KR) 10-2023-0129024
Nov. 23, 2023 (KR) 10-2023-0163977

(51) Int. Cl. C02F 1/00; C02F 1/32

(52) U.S. Cl. CPC C02F 1/008; C02F 1/32; C02F 2201/005; C02F 2201/326; C02F 2209/008; C02F 2209/11; C02F 2303/04

(57) ABSTRACT

An embodiment relates to an apparatus and method for supplying safe potable water, and more specifically, to an apparatus and method for supplying safe potable water that permits release of tap water only when turbidity of tap water satisfies a preset standard value by measuring the turbidity, and only when there are no foreign materials by inspecting whether foreign materials exist in water based on a water image taken with a camera of tap water to be supplied, and displays foreign material identification information including the measured turbidity and water image, to make a drinker aware that the tap water is clean, and releases tap water after sterilizing the tap water which is to be released upon release request by the drinker with UV.

### CROSS-REFERENCE TO RELATED APPLICATION

This application claims the benefit of Korean Patent Application No. 10-2023-0129024 filed on Sep. 26, 2023 and Korean Patent Application No. 10-2023-0163977 filed on Nov. 23, 2023, in the Korean Intellectual Property Office, the entire disclosure of which is incorporated herein by reference for all purposes.

### BACKGROUND

### 1. Field of the Invention

The present disclosure relates to an apparatus and method for supplying safe potable water, and more specifically, to an apparatus and method for supplying safe potable water that permits release of tap water only when turbidity satisfies a preset standard value by measuring the turbidity of tap water, and only when there are no foreign materials (or “particles”) by inspecting whether foreign materials exist in the water based on a water image taken by a camera of tap water to be supplied, and displays foreign material identification information including the measured turbidity and water image, to make a drinker aware that the tap water is clean, and releases after sterilizing tap water which is to be released upon release request by the drinker with UV, allowing citizens to drink tap water with confidence.

### 2. Description of the Related Art

Every year, the government spends trillions of dollars in budget and effort to produce clean and safe tap water.

However, due to distrust in the safety of tap water, people do not drink tap water directly, but instead pay high costs to use water purifiers or purchase bottled water to drink.

Although tap water is cleanly treated and supplied, most tap water is used for non-drinking purposes such as washing dishes, laundry, and bathing.

Therefore, the government is spending a lot of effort and high costs to increase the drinking rate of tap water. Although these efforts have increased people's satisfaction with and use of tap water, the drinking rate of using tap water for drinking remains at around 5%.

In addition, even when using a water purifier, the number of damage and complaint cases reported to the Korea Consumer Protection Agency due to water quality problems of the water purifier due to poor water purifier management is increasing every year.

It has also been revealed that one out of three bottled water sellers have been selling drinking spring water supplied by a company that violates water quality standards.

In order to solve these problems, Korean Patent No. 10-1632732 (published on Jun. 23, 2016), titled Dispenser Water Quality Information Providing System (hereinafter referred to as “prior art”), provides reliability for tap water supplied to a same water quality facility zone by measuring water quality of a main dispenser installed in the same water quality facility zone, providing the measured water quality to other dispensers in the same water quality facility zone to display the same to make the public aware of the safety of tap water.

Although the above prior art provides a certain level of reliability to the public, there are limitations in providing the public with reliability regarding tap water by displaying only simple numbers.

This is because the public still has vague anxiety about the water quality of tap water, and measures to fundamentally resolve this are required.

### SUMMARY

Therefore, an object of the present disclosure is to provide an apparatus and method for supplying safe potable water, and more specifically, to an apparatus and method for supplying safe potable water that permits release of tap water only when turbidity satisfies a preset standard value by measuring the turbidity of tap water, and only when there are no foreign materials by inspecting whether foreign materials exist in the water based on a water image taken by a camera of tap water to be supplied, and displays foreign material identification information including the measured turbidity and water image, to make a drinker aware that the tap water is clean, and releases after sterilizing the tap water which is to be released upon release request by the drinker with UV, allowing citizens to drink tap water with confidence.

An apparatus for supplying safe potable water according to the present disclosure to achieve the above object includes: a display unit; a turbidity measuring unit including a first water tank, which is configured to receive tap water and discharge it to outside through the first water tank, and measure turbidity of the tap water flowing through the first water tank; an image water quality measuring unit including a second water tank, which is configured to discharge tap water supplied from the turbidity measuring unit through the second water tank and output a water image taken of the tap water supplied to the second water tank; a sterilization unit configured to sterilize the tap water introduced through the turbidity measuring unit and the image water quality measuring unit with UV; a release unit configured to release the UV-sterilized tap water from the sterilizing unit to outside as drinking water; and a control module configured to analyze the water image input from the image water quality measuring unit to inspect whether foreign materials exist in the tap water, and display the water image, foreign material identification information that is a foreign material inspection result by the water image, and the measured turbidity on the display unit.

The apparatus may further include: a drinking water supply unit configured to water-process the tap water supplied from the image water quality measuring unit under control and release it as drinking water to the sterilization unit; and a water processing unit configured to receive tap water from a water pipe and release the tap water to the turbidity measuring unit, or discharge the tap water supplied to the turbidity measuring unit, the image water quality measuring unit, and the drinking water supply unit to outside, and the control module may be configured to, when the turbidity exceeds a standard value or foreign materials exist, discharge the tap water supplied through the water processing unit to outside, and when the turbidity is below the standard value or no foreign materials exist, process permission to release tap water so that the the tap water is released through the sterilization unit and the release unit.

The turbidity measuring unit may be disposed to be tilted at a predetermined angle with respect to a vertical or horizontal direction so that the water tank has a rhombus shape, and configured so that an outlet is formed at an upper vertex part of the rhombus.

The apparatus may further include an input unit comprising an input means for generating a water processing command of tap water, and the control module may include: a drinking water release interface unit configured to display a drinking water release interface means comprising a water processing means capable of generating the water processing command through the display unit, and generate and output a water processing command input by a user through the input unit and the drinking water release interface means; a turbidity identification unit configured to control the turbidity measuring unit to acquire the turbidity of the tap water in the first water tank of the turbidity measuring unit, determine whether the turbidity exceeds a preset standard value, and output result information; an image particle identification unit configured to control the image water quality measuring unit to acquire the water image of the tap water filled in the second water tank of the image water quality measuring unit, determine whether foreign materials exist in the acquired water image, and output foreign material identification information; a UV controller configured to drive the sterilization unit when a sterilization unit driving event occurs; and a release controller configured to, when it is determined that the turbidity exceeds the standard value or foreign materials exist based on the result information and the foreign material identification information, discharge tap water supplied through the water processing unit to the outside, and when the turbidity is below the standard value or no foreign materials exist, process permission to release tap water so that the tap water is released through the sterilization unit and the release unit, and control the drinking water supply unit to perform water processing according to the water processing command.

The image particle identification unit may be configured to, when photographing the tap water in the second water tank, acquire an upper water image, a middle water image, and a lower water image taken in three stages of upper, middle, and lower parts of the second water tank, and determine whether foreign materials exist for each of the upper water image, middle water image, and lower water image.

The image particle identification unit may be configured to generate differential images by differentiating between two sequential water images among water images of three consecutive frames, perform a pixel multiplication operation on two differential images (Diff1, Diff2) to generate a detection image, and then count the number of pixels that have changed in the detection image, and when the counted number of pixels exceeds a preset standard value, determine that foreign materials exist.

A method of supplying safe potable water according to the present disclosure to achieve the above object includes: a turbidity measuring process in which a control module measures turbidity of tap water supplied to a first water tank, wherein a turbidity measuring unit comprises the first water tank; an image water quality measuring process in which, through an image water quality measuring unit comprising a second water tank, the control module acquires and analyzes a water image taken of tap water supplied to the second water tank to inspect whether foreign materials exist in the tap water, and outputs foreign material identification information which is result information thereof; a potable water quality information display process in which the control module displays the water image, the foreign material identification information for the water image, and the measured turbidity on a display unit; and a sterilization process in which the control module controls a sterilization unit to sterilize tap water coming in through the turbidity measuring unit and the image water quality measuring unit with UV.

The method may further include a water supply decision process in which the control module discharges tap water supplied through a water processing unit to outside when the turbidity exceeds a standard value or foreign materials exist, and processes permission to release tap water so that the the tap water is released through the sterilization unit and a release unit when the turbidity is below the standard value or no foreign materials exist.

The image quality measuring process may include: an upper water image acquiring step in which the control module moves a camera of the image water quality measuring unit to an upper part of the second water tank to acquire an upper water image of upper tap water of the second water tank; a middle water image acquiring step in which the control module moves the camera of the image water quality measuring unit to a middle part of the second water tank to acquire a middle water image of middle tap water of the second water tank; a lower water image acquiring step in which the control module moves the camera of the image water quality measuring unit to a lower part of the second water tank to acquire a lower water image of lower tap water of the second water tank; and a foreign material monitoring step in which the control module determines whether foreign materials exist for each of the upper water image, middle water image, and lower water image, and displays the foreign material identification information on the display unit.

The foreign material monitoring step may include: a differential image generating step in which an image particle identification unit generates differential images by differentiating between two sequential water images among water images of three consecutive frames; a detection image generating step in which the image particle identification unit performs a pixel multiplication operation on two differential images (Diff1, Diff2) to generate a detection image; a change amount counting step in which the image particle identification unit counts the number of pixels that have changed in the detection image; and a detection image providing step in which, when the counted number of pixels exceeds a preset standard value, the image particle identification unit determines that foreign materials exist and displays the foreign material identification information on the display unit.

The present disclosure has an effect of improving the reliability of tap water for drinkers by displaying water quality information including the turbidity of tap water for drinking as potable water and the presence or absence of foreign materials based on images, and irradiating ultraviolet rays to sterilize potable water whose water quality has been verified when a release request is occurred by a drinker and then releasing.

In addition, the present disclosure has an effect of eliminating the need for a separate air vent in a turbidity measuring apparatus because the present disclosure disposes the turbidity measuring unit to be tilted in the apparatus and is configured such that tap water enters from the bottom and exits from an upper part, the water tank of the turbidity measuring unit is formed in a rhombus shape so that air bubbles generated from tap water naturally collect at the apex of the water tank formed at the top, and the collected air bubbles are naturally discharged through the outlet formed at the top of the water tank. In this way, since the internal water tank of the turbidity measuring apparatus is maintained in a vacuum state, preventing foreign materials and bacteria from infiltrating into the water tank from the outside, there is an effect of improving the accuracy of turbidity measurement by preventing measurement errors caused by external foreign materials and bacterial infiltration.

### BRIEF DESCRIPTION OF THE DRAWINGS

FIG. 1 is a block diagram of an apparatus for supplying safe potable water according to the present disclosure.

FIG. 2 is a diagram illustrating a mechanical configuration based on a tap water path inside the apparatus for supplying safe potable water according to the present disclosure.

FIG. 3 is a diagram for explaining a configuration of a turbidity measuring unit and a bubble removal method of the apparatus for supplying potable water according to the present disclosure.

FIG. 4 is a diagram illustrating a detailed configuration of a control module of the apparatus for supplying potable water according to the present disclosure.

FIG. 5 is a flowchart illustrating a method of supplying potable water according to an embodiment of the present disclosure.

FIG. 6 is a flowchart illustrating an image-based foreign material detection method of the method of supplying potable water according to an embodiment of the present disclosure.

### DETAILED DESCRIPTION

Hereinafter, with reference to the accompanied drawings, configurations and operations of an apparatus for supplying safe potable water according to the present disclosure will be described in detail, and a method of supplying safe potable water of the apparatus will be described.

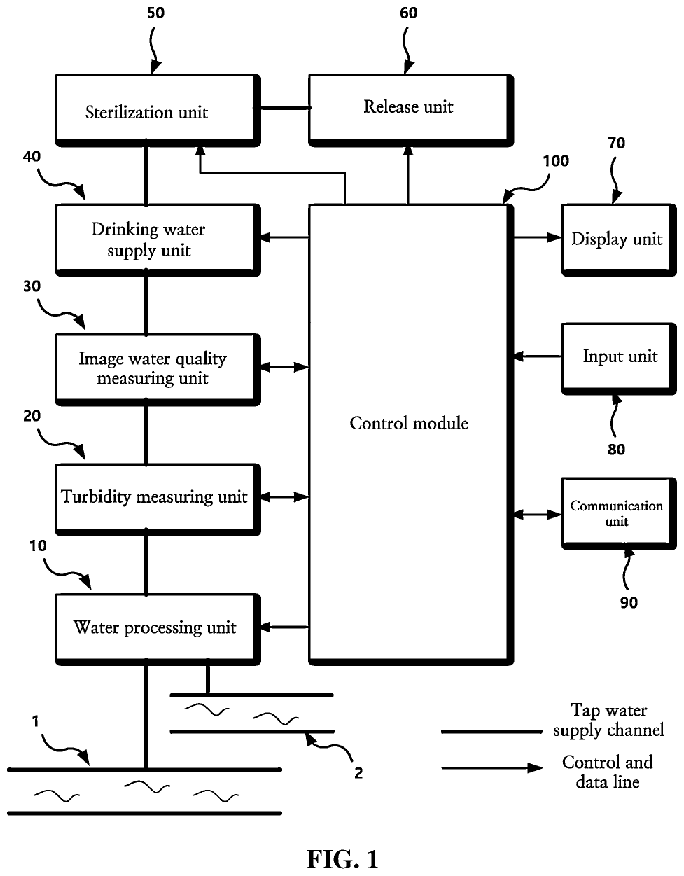

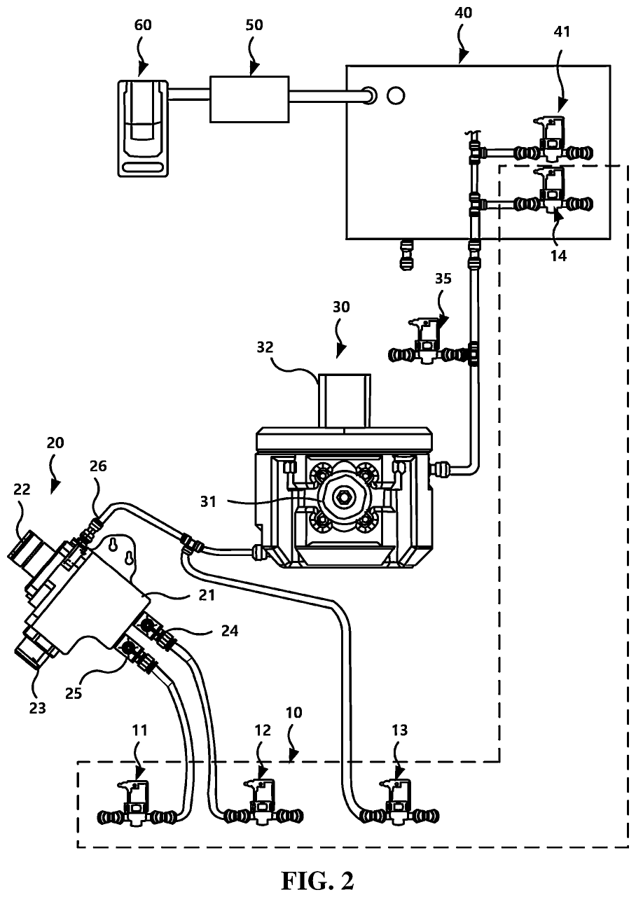

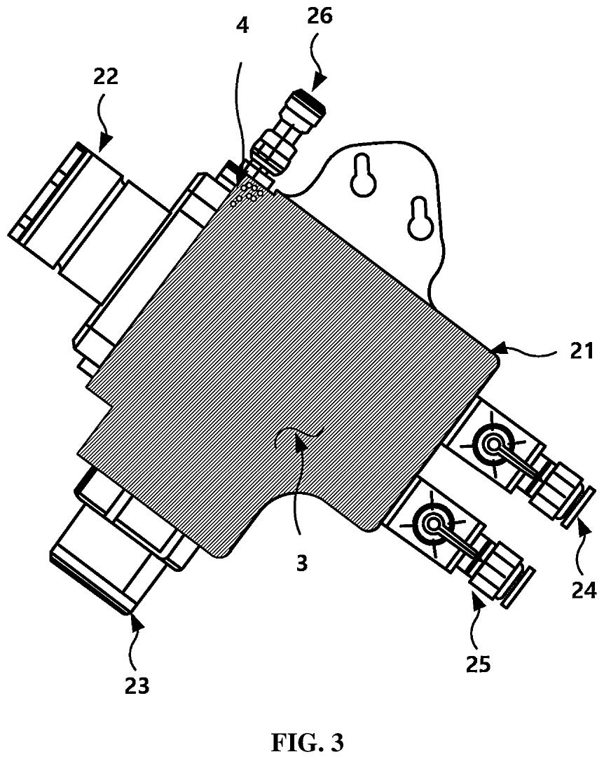

FIG. 1 is a block diagram of a apparatus for supplying safe potable water according to the present disclosure, FIG. 2 is a diagram illustrating a mechanical configuration based on a tap water path inside the apparatus for supplying safe potable water according to the present disclosure, and FIG. 3 is a diagram for explaining a configuration of a turbidity measuring unit and a bubble removal method of the apparatus for supplying potable water according to the present disclosure. Hereinafter, description will be made with reference to FIGS. 1 to 3.

An apparatus for supplying safe potable water according to the present disclosure includes a turbidity measuring unit 20, an image water quality measuring unit 30, a sterilization unit 50, a release unit 60, a display unit 70, and a control module 100, and according to embodiments, may further include a water processing unit 10, a drinking water supply unit 40, an input unit 80, and a communication unit 90.

As shown in FIG. 2, the water processing unit 10 includes a tap water supply valve 12 connected to a water pipe 1 and supplying tap water supplied from the water pipe 1 to the turbidity measuring unit 20, a cleaning valve 11 discharging tap water supplied to the turbidity measuring unit 20, a camera cleaning valve 13 discharging tap water supplied to the image water quality measuring unit 30, and a direct pipe cleaning valve 14 discharging tap water supplied to the drinking water supply unit 40.

The water processing unit 10 supplies tap water from the water pipe 1 to the turbidity measuring unit 20 under the control of the control module 100, or discharges tap water supplied to the turbidity measuring unit 20, the image water quality measuring unit 30, and the drinking water supply unit 40 into a sewer pipe 2 or to the outside.

As shown in FIG. 3, the turbidity measuring unit 20 includes a main body 21, a turbidity lamp 22, a turbidity sensor 23, an inlet 24, a drain 25, and an outlet 26.

The main body 21 includes a first water tank 3 having a space inside.

The turbidity lamp 22 is configured at the upper end of the main body 21 and irradiates light into the inner space of the first water tank 3.

The turbidity sensor 23 is configured on the left or right side of the main body 21 and measures the turbidity of the tap water filled in the first water tank 3 and outputs the to the control module 100.

The inlet 24 penetrates and connects to the first water tank 3 at the lower end of the main body 21 and is connected to the tap water supply valve 12 to supply tap water from the water pipe 1 to the first water tank 3. According to the embodiment, the inlet 24 may be directly connected to the water pipe 1, and an inlet valve (not shown) that supplies or blocks tap water from the water pipe 1 to the first water tank 3 under the control of the control module 100 may be further included.

The drain 25 penetrates and connects to the first water tank 3 and is connected to the cleaning valve 11 to discharge the tap water filled in the first water tank 3 to the outside under the control of the control module 100.

The outlet 26 is configured at the upper edge of the first water tank 3, penetrates and connects to the first water tank 3, and is connected to the image water quality measuring unit 30 to supply tap water filled in the first water tank 3 to the image water quality measuring unit 30.

The turbidity measuring unit 20 is disposed to be tilted at a predetermined angle in the apparatus for supplying safe potable water so that the outlet 26 is located at the vertex of the rhombus with respect to the vertical or horizontal direction as shown in FIG. 3.

This is to ensure that, as shown in FIG. 3, the first water tank 3 is formed in a rhombus shape with respect to the horizontal direction, and that air bubbles 4 generated in the tap water supplied to the first water tank 3 are naturally collected at the upper vertex of the rhombus. The air bubbles 4 collected at the vertex of the first water tank 3 will be discharged from the first water tank 3 to the outside through the outlet 26 when the tap water in the first water tank 3 is supplied to the image water quality measuring unit 30. The air bubbles discharged to the outside through the outlet 26 may be configured to be discharged through an air vent valve 35 configured in a hose between the image water quality measuring unit 30 and the drinking water supply unit 40 while being supplied to the drinking water supply unit 40 through the image water quality measuring unit 30.

In this way, since the turbidity measuring unit 20 of the present disclosure does not need to be configured with an air vent, the space of the first water tank 3 is not exposed to the external environment, and thus the inflow of foreign materials and bacteria into the first water tank 3, which occurs when air bubbles are removed by using an air vent, may be prevented. In other words, since the space of the first water tank 3 is not exposed to the external environment, the turbidity measuring unit 20 of the present disclosure may measure water quality only for supplied tap water, thereby preventing measurement errors due to the inflow of external contaminants.

The image water quality measuring unit 30 includes a second water tank (not shown) having a space inside which tap water is supplied, and includes a lighting unit 31 that irradiates light into the second water tank and a camera 32 that photographs tap water filled in the second water tank and outputs a water image.

The image water quality measuring unit 30 in FIG. 2 is tilted 90 degrees to the right, and according to the embodiment, the camera 30 is configured to move up and down (left and right in FIG. 2) along the second water tank, and performs photographing by dividing into upper, middle, and lower parts and provides the upper water image, middle water image, and lower water image to the control module 100.

The drinking water supply unit 40 is configured according to the embodiment to receive tap water from the image water quality measuring unit 30, perform water processing under the control of the control module 100, and supplies it to the sterilization unit 50. Here, the water processing means heating the supplied tap water to a preset temperature and discharging it, cooling it to a preset temperature and discharging it, or discharging it as is.

The sterilization unit 50 is driven under the control of the control module 100, sterilizes the tap water supplied from the drinking water supply unit 40 by irradiating ultraviolet rays (UV), and then supplies it to the release unit 60.

The release unit 60 may include a release button according to the embodiment, and when the release button is pressed or a release command is input from the control module 100, the tap water supplied from the sterilization unit 50 is released to the outside as drinking water.

The display unit 70 may be a liquid crystal display (LCD) display device, an organic light emitting diode (OLED) display device, etc, and is controlled by the control module 100 to display various information in one or more of text, graphics, still images, and videos.

The input unit 80 includes one or more of a button input device including a number of buttons to select hot water, cold water, lukewarm water, tap water (untreated tap water), etc., and a touch pad that is integrated with the screen of the display unit 120 and outputs a location signal corresponding to the location of the screen being touched to the control module to allow selection of hot water release, cold water release, lukewarm water release, tap water release, UV driving, turbidity measurement, foreign material identification, etc., by touch through a drinking water release interface means, which is a user graphic interface means displayed on the screen of the display unit 70.

The communication unit 90 enables data communication with a management system (not shown), a computer terminal used by a manager of the apparatus for supplying safe potable water, and a manager terminal such as a smart terminal, through a data communication network that combines one or more of an Internet network including a Wi-Fi network, a mobile communication network including 3rd Generation (3G), 4G, and 5G, and the like.

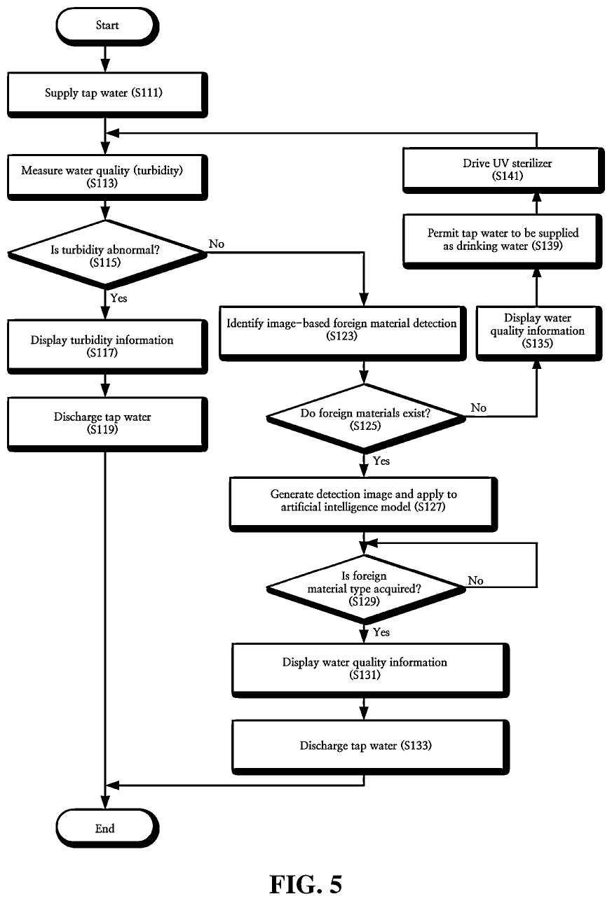

The control module 100 controls the overall operation of the apparatus for supplying safe potable water according to the present disclosure. The detailed configuration and operation of the control module 100 will be described with reference to FIG. 5 below.

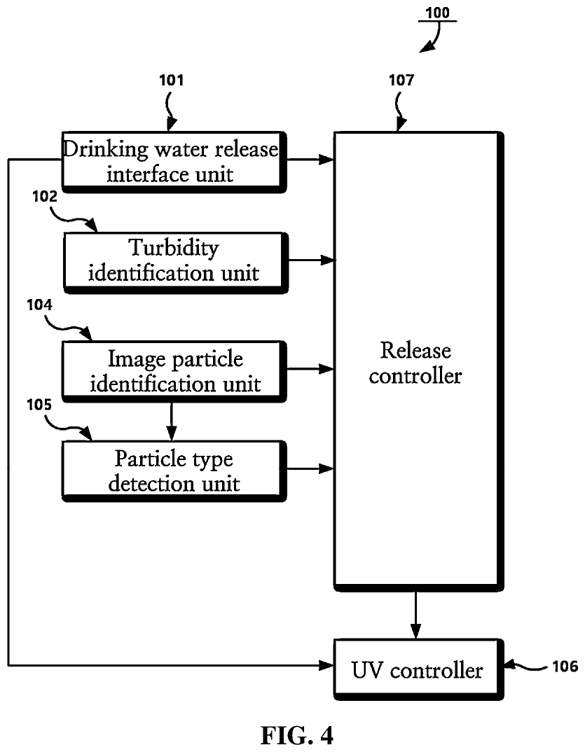

FIG. 4 is a diagram illustrating a detailed configuration of the control module of the apparatus for supplying potable water according to the present disclosure.

Referring to FIG. 4, the control module 100 includes a drinking water release interface unit 101, a turbidity identification unit 102, an image particle identification unit 104, a particle type detection unit 105, a UV controller 106, and a release controller 107.

The drinking water release interface unit 101 displays a drinking water release interface means on the display unit 70 and receives a user water processing command through the input unit 80 or the drinking water release interface means and input unit 80, and outputs a water processing command corresponding to the user water processing command to the corresponding configuration among the release controller 107, turbidity identification unit 102, image particle identification unit 104, particle type detection unit 105, and UV controller 106. The water processing command may be a hot water release command, a lukewarm water release command, a cold water release command, a tap water release command, a turbidity identification command, a foreign material identification command, a foreign material type detection command, a UV driving command, or the like.

The drinking water release interface unit 101 collects turbidity, water image, foreign material identification result information, foreign material type information, etc., from the turbidity identification unit 102, image particle identification unit 104, and particle type detection unit 105 and displays through the drinking water release interface means.

When a turbidity identification event occurs, the turbidity identification unit 102 acquires the turbidity of tap water supplied to the first water tank 3 through the turbidity measuring unit 20 and outputs to the drinking water release interface unit 101, determines whether the acquired turbidity exceeds a preset standard value and outputs the result information to the release controller 107. The turbidity identification event may occur at a preset regular interval, or may occur when the turbidity identification command is input from the input unit 80 and the communication unit 90. The turbidity identification command may be generated when the input unit 80 or the turbidity identification button of the input unit 80 and the drinking water release interface means is pressed or clicked, and may be received from a remote management system (not shown) and a manager terminal through the communication unit 90.

The image particle identification unit 104 controls the image water quality measuring unit 30 to acquire a water image of the tap water filled in the second water tank of the image water quality measuring unit 30, determines whether foreign materials exist in the acquired water image and outputs the foreign material identification information to the drinking water release interface unit 101, the particle type detection unit 105, and the release controller 107.

The image particle identification unit 104 performs photographing while sequentially moving the camera 32 of the image water quality measuring unit 30 to the upper, middle, and lower parts of the second water tank to more precisely determine whether foreign materials exist in the tap water filled in the second water tank of the image water quality measuring unit 30, and acquires an upper water image photographing tap water in the upper part of the second water tank, a middle water image photographing tap water in the middle part, and a lower water image photographing tap water in the lower part.

When the upper water image, the middle water image photographing tap water in the middle part, and the lower water image photographing tap water in the lower part are acquired, the image particle identification unit 104 determines whether foreign materials exist in each of the upper water image, middle water image, and lower water image.

To describe the method of detecting foreign materials in the image particle identification unit 104, the image particle identification unit 104 acquires three water images, which are consecutive frame images, from the camera 32 and converts each water image into grayscale (black and white) to determine whether foreign materials exist in the water images.

When three grayscaled water images are acquired, the image particle identification unit 104 generates differential images (Diff1, Diff2) based on differences between frames as shown in Equation 1 below, generates a detection image by performing a pixel multiplication operation on the two differential images, and counts the number of pixels that have changed in the detection image.

$$Diff 1 = frame 1 - frame 2 \qquad [ Equation 1 ]$$

$$Diff 2 = frame 2 - frame 3$$

$$Detection Image = Diff 1 and Diff 2$$

The image particle identification unit 104 ignores the amount of change if the counted number of pixels is less than a preset standard value, and if it exceeds the standard value, considers there to be foreign materials and outputs the detection image to the particle type detection unit 105.

The particle type detection unit 105 includes a foreign material classification artificial intelligence model trained by multiple images of various foreign materials or multiple images containing different foreign materials, and training data labeled with foreign material identification information included in each image. The foreign material identification information may be an identification number uniquely assigned to each foreign material, or may be the name of the foreign material.

When a detection image is input from the image particle identification unit 104, the particle type detection unit 105 applies the detection image to the foreign material classification artificial intelligence model to identify the type of foreign material included in the detection image, and provides foreign material type information to the drinking water release interface unit 101.

According to another embodiment, the foreign material classification artificial intelligence model may be configured in a separate foreign material classification server (not shown) that is connected to the apparatus for supplying safe potable water of the present disclosure through an Internet network (not shown) and can communicate through the communication unit 90.

In this case, the particle type detection unit 105 transmits the detection image input from the image particle identification unit 104 to the foreign material classification server, receives and stores foreign material type information classified by applying the detection image to the foreign material classification artificial intelligence model from the foreign material classification server, and then displays on the display unit 70 through the drinking water release interface unit 101.

When a UV driving event occurs, the UV controller 106 controls the sterilization unit 50 to irradiate UV to the image water quality measuring unit 30 or the supply pipe that supplies tap water from the drinking water supply unit 40 to the release unit 60. The UV driving event may occur only once when power is supplied to the apparatus for supplying safe potable water, may occur upon release request through the release unit 60 or input unit 80, and may occur when a UV driving command is input through the input unit 80 and the drinking water release interface means. In other words, the sterilization unit 50 may be driven when power is supplied and operate continuously until the apparatus is turned off, may be driven continuously from the time the UV driving command is input until the apparatus is turned off or a UV driving end command is input, and may be driven only for a predetermined period of time when a release request occurs.

The release controller 107 is configured to, based on the result information input from the turbidity identification unit 102 and the foreign material identification information input from the image particle identification unit 104, when the turbidity exceeds a standard value or foreign materials exist, discharge tap water supplied through the water processing unit 10 to the outside, and when the turbidity is below the standard value or foreign materials do not exist, process permission to release tap water so that the the tap water can be released through the sterilization unit 50 and the release unit 60, and control the drinking water supply unit 40 to perform water processing according to the water processing command.

FIG. 5 is a flowchart illustrating a method of supplying potable water according to the present disclosure.

Referring to FIG. 5, when the water processing unit 10 or the turbidity measuring unit 20 is connected to the water pipe 1, the control module 100 controls the water processing unit 10 to supply tap water to the turbidity measuring unit 20 or controls an inlet valve (not shown) provided at the inlet 24 of the turbidity measuring unit 20 to supply tap water to the turbidity measuring unit 20 (S111).

The control module 100 measures turbidity through the turbidity measuring unit 20 when tap water begins to be supplied (S113), displays the turbidity on the display unit 70 when the turbidity exceeds the standard value (S117), controls the water processing unit 10 to discharge tap water supplied to the turbidity measuring unit 20, the image water quality measuring unit 30, and the drinking water supply unit 40 to the outside (S119).

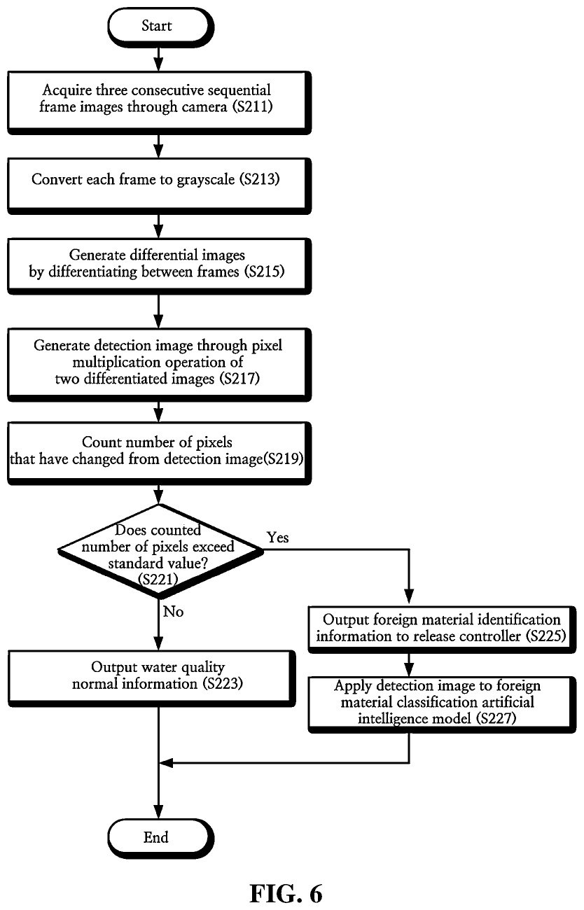

When the turbidity is normal, the control module 100 generates differential images by the differentiation between three consecutive water images taken of tap water supplied through the image water quality measuring unit 30, inspects whether foreign materials exist in the tap water based on the generated differential image (S123) and determines whether foreign materials exist (S125). The foreign material detection method will be described in detail with reference to FIG. 6 below.

When a foreign material is detected by inspecting the presence of foreign materials based on an image, the control module 100 displays water quality information including turbidity, water image, etc., on the display unit 70 (S131), controls the water processing unit 10 to discharge tap water supplied into the apparatus to the outside (S133).

According to the embodiment, the control module 100 generates a detection image through a pixel multiplication operation of two differential images (Diff1, Diff2) generated by the differentiation between the three water images generated upon foreign material detection and applies it to a foreign material classification artificial intelligence model, or transmits the detection image to the foreign material classification server (not shown) having the foreign material classification artificial intelligence model (S127), monitors whether the classified foreign material type is acquired (S129), and when the type of foreign material is output, will display foreign material type information including foreign material information and a foreign material image when displaying the water quality information. The control module 100 must store a foreign material image corresponding to the foreign material information.

On the other hand, when the turbidity of tap water is normal and foreign materials do not exist, the control module 100 displays water quality information including turbidity and water images without foreign materials on the display unit 70 (S135) and performs tap water supply permission processing to permit tap water to be supplied as drinking water (S139).

When the tap water supply permission is processed, the control module 100 drives the UV sterilizer 50 to sterilize the tap water supplied to the release unit 60 (S141).

FIG. 6 is a flowchart illustrating an image-based foreign material detection method of the method of supplying potable water according to the present disclosure.

Referring to FIG. 6, the image particle identification unit 104 of the control module 100 acquires a water image which is three consecutive sequential frame images, through the camera 32 of the image quality measuring unit 30 (S211).

When three consecutive water images are acquired, the image particle identification unit 104 performs grayscale conversion on each frame, i.e., each water image, to convert into a black and white image (S213).

The image particle identification unit 104 generates differential images (Diff1, Diff2) by performing differentiation (frame1-frame2, frame2-frame3) between the three water images (frame1, frame2, frame3) converted to black and white images as shown in Equation 1 (S215).

When the differential image is generated, the image particle identification unit 104 generates a detection image by performing a pixel multiplication operation on the differential image (S217). When the water image contains foreign material, the detection image will correspond to the foreign material image.

When the detection image is generated, the image particle identification unit 104 counts the number of pixels in which a change has occurred in the detection image (S219).

When the number of pixels is counted, the image particle identification unit 104 determines whether the number of pixels exceeds a preset standard value (S221).

As a result of the determination, when the number of pixels is less than the standard value, the image particle identification unit 104 ignores (discards) the captured water image and outputs water quality information indicating that the water quality is normal to the release controller 107, and displays on the display unit 70 through the drinking water release interface unit 101 (S223).

On the other hand, when it is determined that the number of pixels exceeds the above standard value and a foreign material exist, the image particle identification unit 104 outputs foreign material identification information indicating that a foreign material has been detected to the release controller 107 (S225), and provides the detection image to the particle type detection unit 105 (S227).

Those skilled in the art will easily understand that the present disclosure is not limited to the above-described typical preferred embodiments, but can be implemented by various improvements, changes, substitutions, or additions without departing from the gist of the present disclosure. If the implementation by such improvement, change, substitution or addition falls within the scope of the appended claims below, the technical idea thereof should also be regarded as belonging to the present disclosure.

### EXPLANATION OF SYMBOLS

1: Water pipe 3: First tank
10: Water processing unit 11: Cleaning valve
12: Tap water supply valve 13: Camera cleaning valve
14: Direct pipe cleaning valve 20: Turbidity measuring unit
21: Main body 22: Turbidity lamp
23: Turbidity sensor 24: Inlet
25: Drain 26: Outlet
30: Image water quality measuring unit 31: Lighting lamp
32: Camera 40: Drinking water supply unit
50: Sterilization unit 60: Release unit
70: Display unit 80: Input unit
90: Communication unit 100: Control module
101: Drinking water release interface unit 102: Turbidity identification unit
104: Image particle identification unit 105: Particle type detection unit
106: UV controller 107: Release controller

What is claimed is:

1. An apparatus for supplying safe potable water, the apparatus comprising:
a display unit;
a turbidity measuring unit comprising a first water tank, which is configured to receive tap water and discharge it to outside through the first water tank, and measure turbidity of the tap water flowing through the first water tank;
an image water quality measuring unit comprising a second water tank, which is configured to discharge tap water supplied from the turbidity measuring unit through the second water tank and output a water image taken of the tap water supplied to the second water tank;
a sterilization unit configured to sterilize the tap water introduced through the turbidity measuring unit and the image water quality measuring unit with UV;
a release unit configured to release the UV-sterilized tap water from the sterilization unit to outside as drinking water; and
a control module configured to analyze the water image input from the image water quality measuring unit to inspect whether foreign materials exist in the tap water, and display the water image, foreign material identification information that is a foreign material inspection result by the water image, and the measured turbidity on the display unit.

2. The apparatus of claim 1, further comprising:
a drinking water supply unit configured to water-process the tap water supplied from the image water quality measuring unit under control and release it as drinking water to the sterilization unit; and
a water processing unit configured to receive tap water from a water pipe and release the tap water to the turbidity measuring unit, or discharge the tap water supplied to the turbidity measuring unit, the image water quality measuring unit, and the drinking water supply unit to outside,
wherein the control module is configured to, when the turbidity exceeds a standard value or foreign materials exist, discharge the tap water supplied through the water processing unit to outside, and when the turbidity is below the standard value or no foreign materials exist, process permission to release tap water so that the the tap water is released through the sterilization unit and the release unit.

3. The apparatus of claim 2, wherein the turbidity measuring unit is disposed to be tilted at a predetermined angle with respect to a vertical or horizontal direction so that the water tank has a rhombus shape, and configured so that an outlet is formed at an upper vertex part of the rhombus.

4. The apparatus of claim 3, further comprising:
an input unit comprising an input means for generating a water processing command of tap water,
wherein the control module comprises:
a drinking water release interface unit configured to display a drinking water release interface means comprising a water processing means capable of generating the water processing command through the display unit, and generate and output a water processing command input by a user through the input unit and the drinking water release interface means;
a turbidity identification unit configured to control the turbidity measuring unit to acquire the turbidity of the tap water in the first water tank of the turbidity measuring unit, determine whether the turbidity exceeds a preset standard value, and output result information;
an image particle identification unit configured to control the image water quality measuring unit to acquire the water image of the tap water filled in the second water tank of the image water quality measuring unit, determine whether foreign materials exist in the acquired water image, and output foreign material identification information;
a UV controller configured to drive the sterilization unit when a sterilization unit driving event occurs; and
a release controller configured to, when it is determined that the turbidity exceeds the standard value or foreign materials exist based on the result information and the foreign material identification information, discharge tap water supplied through the water processing unit to the outside, and when the turbidity is below the standard value or no foreign materials exist, process permission to release tap water so that the tap water is released through the sterilization unit and the release unit, and control the drinking water supply unit to perform water processing according to the water processing command.

5. The apparatus of claim 4, wherein the image particle identification unit is configured to, when photographing the tap water in the second water tank, acquire an upper water image, a middle water image, and a lower water image taken in three stages of upper, middle, and lower parts of the second water tank, and determine whether foreign materials exist for each of the upper water image, middle water image, and lower water image.

6. The apparatus of claim 5, wherein the image particle identification unit is configured to generate differential images by differentiating between two sequential water images among water images of three consecutive frames, perform a pixel multiplication operation on two differential images (Diff1, Diff2) to generate a detection image, and then count the number of pixels that have changed in the detection image, and when the counted number of pixels exceeds a preset standard value, determine that foreign materials exist.

7. A method of supplying safe potable water, the method comprising:
a turbidity measuring process in which a control module measures turbidity of tap water supplied to a first water tank, wherein a turbidity measuring unit comprises the first water tank;
an image water quality measuring process in which, through an image water quality measuring unit comprising a second water tank, the control module acquires and analyzes a water image taken of tap water supplied to the second water tank to inspect whether foreign materials exist in the tap water, and outputs foreign material identification information which is result information thereof;
a potable water quality information display process in which the control module displays the water image, the foreign material identification information for the water image, and the measured turbidity on a display unit; and
a sterilization process in which the control module controls a sterilization unit to sterilize tap water coming in through the turbidity measuring unit and the image water quality measuring unit with UV.

8. The method of claim 7, further comprising:
a water supply decision process in which the control module discharges tap water supplied through a water processing unit to outside when the turbidity exceeds a standard value or foreign materials exist, and processes permission to release tap water so that the the tap water is released through the sterilization unit and a release unit when the turbidity is below the standard value or no foreign materials exist.

9. The method of claim 8, wherein the image quality measuring process comprises:
an upper water image acquiring step in which the control module moves a camera of the image water quality measuring unit to an upper part of the second water tank to acquire an upper water image of upper tap water of the second water tank;
a middle water image acquiring step in which the control module moves the camera of the image water quality measuring unit to a middle part of the second water tank to acquire a middle water image of middle tap water of the second water tank;
a lower water image acquiring step in which the control module moves the camera of the image water quality measuring unit to a lower part of the second water tank to acquire a lower water image of lower tap water of the second water tank; and
a foreign material monitoring step in which the control module determines whether foreign materials exist for each of the upper water image, middle water image, and lower water image, and displays the foreign material identification information on the display unit.

10. The method of claim 9, wherein the foreign material monitoring step comprises:
a differential image generating step in which an image particle identification unit generates differential images by differentiating between two sequential water images among water images of three consecutive frames;
a detection image generating step in which the image particle identification unit performs a pixel multiplication operation on two differential images (Diff1, Diff2) to generate a detection image;
a change amount counting step in which the image particle identification unit counts the number of pixels that have changed in the detection image; and
a detection image providing step in which, when the counted number of pixels exceeds a preset standard value, the image particle identification unit determines that foreign materials exist and displays the foreign material identification information on the display unit.
